(19) United States
(12) Patent Application Publication
(10) Pub. No.: US 2006/0143955 A1
(43) Pub. Date: Jul. 6, 2006

(54) Method and system for searching for and rescuing occupants during natural disasters and other emergency events

(76) Inventor: Mark Boyd, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/273,823

(22) Filed: Nov. 15, 2005

Related U.S. Application Data
(60) Provisional application No. 60/628,514, filed on Nov. 16, 2004.

(51) Int. Cl. G09F 3/10; G09F 1/00

(52) U.S. Cl. 40/299.01; 40/124.01

(57) ABSTRACT

A method and system for aiding rescue workers in properly identifying dwellings that may be in the need of search and rescue occupants of dwellings during natural disasters and other emergency events. The system and method also help rescue workers prioritize the search and rescue efforts to target those dwellings where the occupants have decided to remain, say during a hurricane. Typically, the system includes three decals, two for the resident and one used by rescue workers. The resident typically places either an occupied or vacant decal on the dwelling. The rescue worker can place a search complete decal after appropriate searching has been complete.

Priority based on U.S. Provisional Patent Application Ser. No. 60/628,514, filed Nov. 16, 2004, and entitled, “Method and System for Searching For And Rescuing Occupants During Natural Disasters and Other Emergency Events” is claimed.

### BACKGROUND

I. Field of the Invention

The present invention relates generally to the field of search and rescue, and more particularly, to a method and system for searching for and rescuing occupants of dwellings during natural disasters and other emergency events.

II. Description of the Related Art

Search and rescue teams have the daunting and dangerous task of searching for occupants of structures such as homes during natural disasters that such as hurricanes. Because searchers have no way of knowing which dwellings were occupied and which were not, the process is very time consuming because it involves searching each and every home in the affected area. As such, rescue workers must spend a large amount of time searching homes that have already been evacuated, when they could be spending the time helping those people truly in need of assistance. In addition, there is often little or no way of knowing whether a person in or around a dwelling is an actual occupant or a looter.

### SUMMARY

In general, the invention features a method and system for aiding rescue workers in quickly identifying dwellings that may be in the need of search and rescue occupants of dwellings during natural disasters and other emergency events. The system and method also help rescue workers prioritize the search and rescue efforts to target those dwellings where the occupants have decided to remain, say during a hurricane. Specifically, the system includes three decals, two for the resident and one used by rescue workers. Prior to the storm, the resident places either an orange “occupied” or a yellow “vacant” decal on the dwelling. The rescue worker then affixes a blue “search complete” decal after the appropriate structure search has been completed.

In general, in one aspect, the invention features a search and rescue system, including a first set of decals indicating the occupied state of the dwelling, and a second set of decals indicating the current search state of the dwelling.

In one implementation, the first set of decals is used by the resident of the dwelling.

In another implementation, the second set of decals is used by search and rescue workers.

In another implementation, the first set of decals includes an orange-colored “occupied” decal.

In another implementation, the occupied decal includes informative information regarding the occupied state of the dwelling, such as number of occupants and an emergency phone number.

In another implementation, the first set of decals includes a yellow-colored “vacant” decal.

In another implementation, the second set of decals includes a blue-colored “search complete” decal.

In another implementation, the search complete decal includes information placed by the rescue worker indicating details on the search;

In another implementation, the first set of decals includes instructional application information.

In another implementation, the first and second sets of decals are color coded, as discussed above.

In another implementation, the first and second sets of decals can be reflective.

In another aspect, the invention features a method for search and rescue, including placing upon a dwelling a first decal that indicates whether the dwelling is occupied or not, and placing upon a dwelling a second decal that indicates the dwelling has been searched.

In one implementation, the first decal is an occupied decal.

In another implementation, the occupied decal includes information regarding the number of occupants in the dwelling.

In another implementation, the first decal is a vacant decal.

In another implementation, the first decal is placed by the resident of the dwelling.

In another implementation, the second decal is a search complete decal

In another implementation, the second decal is placed by a rescue worker.

In another implementation, the decals are color coded.

In another implementation, the color codes include an indication for occupied, vacant and search complete.

One advantage of the invention is that rescue workers can quickly identify those dwellings that do or do not have occupants.

Another advantage of the invention is that looters are warned that vacant dwellings are under increased scrutiny by law enforcement.

Another advantage of the invention is that rescue workers can add an indication that a dwelling has been searched.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of an occupied decal;

FIG. 2 illustrates an embodiment of a vacant decal;

FIG. 3 illustrates an embodiment of a search complete decal; and

FIG. 4 illustrates an embodiment of an occupied decal in which information has been entered.

### DETAILED DESCRIPTION

In a typical implementation, hurricanes are a natural occurrence that require residents of affected areas to evacuate. However, the residents often have the option to remain in their homes and wait through the storm. Those residents of the affected areas can be encouraged to pick up a set of decals from a participating organization such as a post office, fire station, police station or other sponsor location. The residents then place the decals upon suitable locations of their residence, typically and desirably on or near the front and, or optionally the back doors of the residence where rescue workers are likely to check when searching dwellings.

In a typical embodiment, the decals have a distinct shape, including but not limited to triangular, rectangular, square, oval, circular, and the like. In addition, the decals are typically color coded for immediate indication to rescue workers which dwellings are occupied during the storm and which are vacated. In one embodiment, orange can be used to identify that the dwelling is occupied and yellow can be used to identify the dwelling as vacant. It is understood that other color schemes can be implemented. It is also further understood that the embodiments contemplate that a standard color code be chosen so that the system and method can be implemented over a large region such as every state of the United States, setting a standard by which rescue workers can rely without confusion, such as by having varying color coding standards region to region. The decals can further be reflective so that their visibility to maximized. The back side of the decal, that is, the peel away portion, can include instructions to the user that can include that the occupied decal should also include a number indicating the number of occupants in the dwellings. In addition, the user can include an emergency contact number in the event the user is injured or incapacitated. In other embodiments, other information can included such as important medical information and the like.

In a typical embodiment, the decals are sized so that they can be viewed from a relatively large distance. For example, the decals can be 12 inches although other sizes are clearly contemplated. The decals also are made of a sturdy durable material such as vinyl that can withstand weather conditions and receive written information, preferably from a permanent marker. The decals include an adhesive strong enough to remain on the chosen surface, but still easily removable from the surface after the storm. The peel away portion, which can include the instructions, is typically discarded. In a typical implementation, the decals are one time use only, and intended to be discarded after use. The one time only feature contemplates that the occupied decal information can change from time to time. In addition, during a subsequent storm, the intent of the occupant can change. For example, the user may intend to stay for the first storm but leave for the second storm. Therefore, two different decals are required for the two different events.

Rescue workers, such as security and law enforcement personnel, arriving immediately after a disaster can be instructed to pay special attention to those homes displaying a “vacant” decal and to detain anyone seen on those premises, as assumed to be looters or other potential criminals. This feature aids law enforcement in that if people are around a dwelling displaying an “occupied” decal, it can be concluded that they are residents that remained for the storm. Furthermore, this feature helps those residents who display a vacant decal from thinking that the display of the vacant decal is an indication to looters to target those dwelling displaying a vacant decal. In fact, by displaying a yellow decal, law enforcement is on an increased level of alert to keep an eye on the dwellings with a vacant decal that no person should be in or around the dwelling with the vacant decal.

In another embodiment, a third decal can be included in the system. The third decal is a “search complete” decal that is placed only be the rescue worker after a thorough search a dwelling is completed. The search complete decal can include a number of boxes on the front into which rescue workers can make notes. The search complete decal can typically be placed on or near the decal placed by the resident.

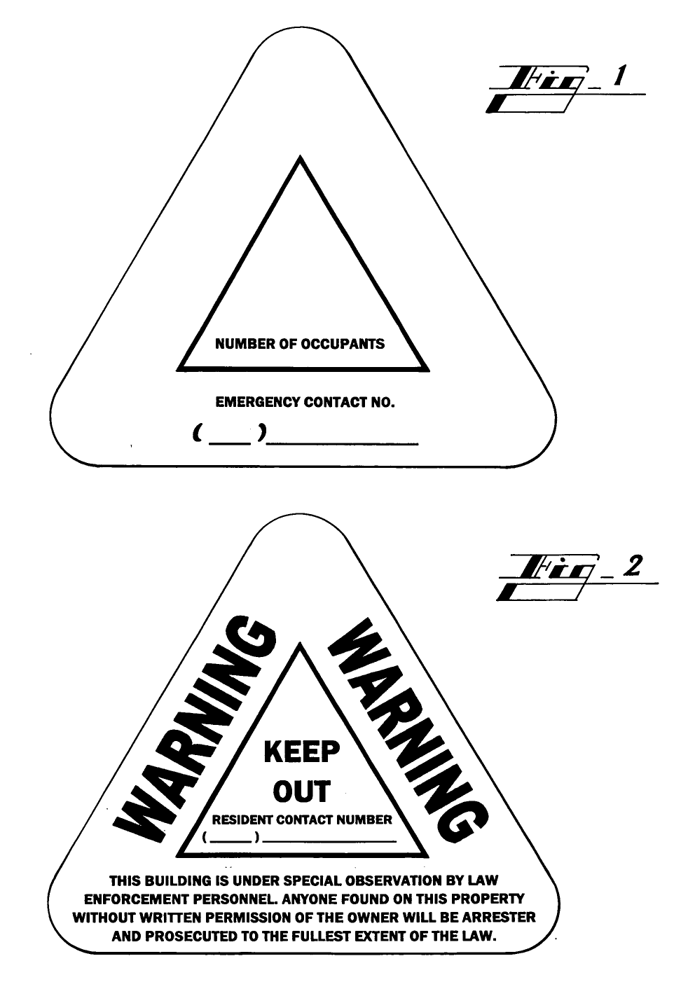

Referring to the drawings wherein like reference numerals designate corresponding parts throughout the several figures, reference is made first to FIG. 1 that illustrates an embodiment of an occupied decal. As described above, the decal has a distinct shape and color, in this case triangular and orange. The decal further includes an inner portion where the number of occupants can be clearly written for immediate indication to a rescue worker. The occupied decal can further include an emergency contact number or other additional information.

FIG. 2 illustrates an embodiment of a vacant decal. As described above, the decal has a distinct shape and color, in this case triangular and yellow. The decal further includes an inner portion that can include a warning message and the owner's phone number where the actual resident can be reached in case law enforcement or other security personnel needs to contact them. The vacant decal can further include any number of other types of warning messages that can include specific laws of the county, state or other region. In one embodiment, the warning can state, “This building is under special observation by law enforcement personnel. Anyone found on this property without written permission of the owner will be arrested and prosecuted to the fullest extent of the law.”

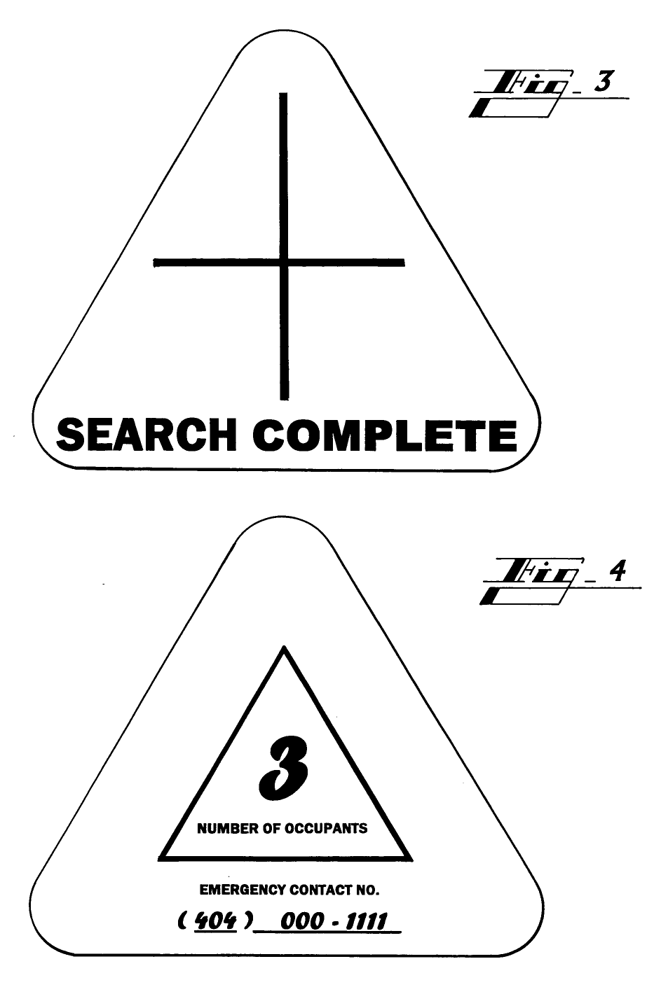

FIG. 3 illustrates an embodiment of a search complete decal. As described above, the decal has a distinct shape and color, in this case triangular and blue. The decal further includes an inner portion that can include boxes into which the rescue worker can write information pertinent to the searched dwelling. The search complete decal can further include any number of other types of warning messages that can include specific laws of the county, state or other region.

FIG. 4 illustrates an embodiment of an occupied decal in which information has been entered. As described above, the decal has a distinct shape and color, in this case triangular and orange. The decal further includes the inner portion where the number of occupants has been clearly written for immediate indication to a rescue worker. The occupied decal further includes an emergency contact number written by the occupant.

In a typical embodiment of the decals described herein, the decals can be desirably 12 inches, self-adhesive peel-off reflective vinyl, with an adhesive that allows the decal to be easily removed after the storm or other event. The decals can include backing sheets that can be easily removed. Typical permanent or felt tip markers can be used to write the above-described information on the decals.

Many of the methods described herein can advantageously be implemented into a computer program to track and monitor the information recorded by the rescue workers. For example, the decals can further include bar codes or other readable mediums that can be scanned or otherwise recorded in an electronic device such as a hand-held PDA or computer. Such information can be stored in a database and accessed as needed.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A search and rescue system, comprising:
a first set of decals, one of the decals placed upon a dwelling, the decal indicating the occupied state of the dwelling; and
a second set of decals indicating the current search state of the dwelling.

2. The system as claimed in claim 1 wherein the first set of decals is used by the resident of the dwelling.

3. The system as claimed in claim 1 wherein the second set of decals is used by search and rescue workers.

4. The system as claimed in claim 1 wherein the first set of decals includes an occupied decal.

5. The system as claimed in claim 4 wherein the occupied decal includes informative information regarding the occupied state of the dwelling.

6. The system as claimed in claim 1 wherein the first set of decals includes a vacant decal.

7. The system as claimed in claim 1 wherein the second set of decals includes a search complete decal.

8. The system as claimed in claim 7 wherein the search complete decal includes information placed by the rescue worker indicating details on the search.

9. The system as claimed in claim 1 wherein the first set of decals includes instructional information.

10. The system as claimed in claim 1 wherein the first and second sets of decals are color coded.

11. The system as claimed in claim 1 wherein the first and second sets of decals are reflective.

12. A method for search and rescue, comprising:
placing upon a dwelling a first decal that indicates whether the dwelling is occupied; and
placing upon a dwelling a second decal that indicates the dwelling has been searched.

13. The method as claimed in claim 12 wherein the first decal is an occupied decal.

14. The method as claimed in claim 13 wherein the occupied decal includes information regarding the number of occupants in the dwelling.

15. The method as claimed in claim 12 wherein the first decal is a vacant decal.

16. The method as claimed in claim 12 wherein the first decal is placed by the resident of the dwelling.

17. The method as claimed in claim 12 wherein the second decal is a search complete decal.

18. The method as claimed in claim 12 wherein the second decal is placed by a rescue worker.

19. The method as claimed in claim 12 wherein the decals are color coded.

20. The method as claimed in claim 19 wherein the color codes include an indication for occupied, vacant and search complete.
